(19) United States
(12) Patent Application Publication
(10) Pub. No.: US 2012/0236743 A1
(43) Pub. Date: Sep. 20, 2012

(54) TRANSMITTING DEVICE AND INFORMATION ACQUISITION CONTROL METHOD

(75) Inventors: Syuichi MUSOU, Kawasaki (JP); Jumpei Hongo, Kawasaki (JP); Masaki Deguchi, Kawasaki (JP)

(73) Assignee: FUJITSU LIMITED, Kawasaki-shi (JP)

(21) Appl. No.: 13/409,679

(22) Filed: Mar. 1, 2012

(30) Foreign Application Priority Data
Mar. 18, 2011 (JP) 2011-061758

(51) Int. Cl. H04L 12/26

(52) U.S. Cl. 370/252

(57) ABSTRACT

A transmitting device includes a counter circuit that counts a counter circuit that counts a value of statistical information of a communication path for certain time periods; a memory; and a control circuit that acquires the value of the statistical information from the counter circuit and causes the memory to store the value of the statistical information when the value of the statistical information acquired by the counter circuit reaches a threshold.

### CROSS-REFERENCE TO RELATED APPLICATION(S)

This application is based upon and claims the benefit of priority of the prior Japanese Patent Application No. 2011-61758, filed on Mar. 18, 2011, the entire contents of which are incorporated herein by reference.

### FIELD

The embodiment discussed herein relates to a transmitting device and an information acquisition control method.

### BACKGROUND

Due to the growth of traffic loads on networks, an administrator conventionally acquires detailed information about traffic on networks by profiling user or application traffic. One type of information is statistical information. Statistical information is accumulated information (count values) of counter numbers such as the number of packets, the number of octets, or the number of errors and the like on a network. Statistical information is used, for example, for diagnosing problems related to network performance, or as periodically acquired and accumulated historical information to be used for operation and maintenance.

Generally, an optical transmitting device manages statistical information related to alarms for each communication path. The optical transmitting device manages the statistical information by storing the statistical information in hardware (HW) counters for each communication path and a central processing unit (CPU) periodically reads out the stored statistical information. The above-mentioned communication paths are packet paths established for conducting the transmission and reception of data between arbitrary nodes on a network. Conventional optical transmitting devices are expected to monitor up to 8192 communication paths per device and sound an alarm when any type of abnormality is detected as a result of reading the statistical information.

For example, if there are 4500 communication paths, hardware constituted by an optical transmitting device collects statistical information from 1 to 4500 communication paths and continuously counts the value of the statistical information using the HW counters. The CPU conducts polling to read out the value of the statistical information at certain polling intervals, and adds the value of the statistical information to a random access memory (RAM). The HW counter includes a read clear register to clear the value of the statistical information to “0” when the CPU reads out the value of the statistical information. The CPU reports the value of the statistical information that exceeds a threshold in a period (for example, 15 minutes) called a bind period (roll over) as an optical transmitting device alarm. In this way, the optical transmitting device manages the devices to acquire the value of the statistical information by enabling a collaboration between the HW counter that continuously collects the value of the statistical information and the CPU operating at a certain timing.

FIG. 10 illustrates conventional polling processing by a CPU. The X-axis in FIG. 10 represents time and the Y-axis represents a value of the statistical information count accumulated in a HW register for each communication path. As illustrated in FIG. 10, the CPU collects the value of the statistical information for all communication paths 1 to 4500 accumulated in the HW register by conducting polling every second as indicated by the times T1 to T5. The CPU causes the collected value of the statistical information to be reflected in a value of the statistical information accumulated value table 30e to manage the value of the statistical information as accumulated values. As a result, the accumulated values of the statistical information for the times T1 to T5 appear as illustrated in the statistical information accumulated value table 30e in FIG. 10. Specifically, at time T1, the accumulated value for all the communication paths 1 to 4500 is “0”. At time T2, the communication paths 1 to 4500 are polled for statistical information counts (in this example, the statistical information count is 1 for communication path 1, and 2 for communication path 4500), and thus the time T2 accumulated values are updated such that communication path 1 is “1”, communication path 2 is “0”, . . . , communication path 4500 is “2”. At time T3, since the statistical information count is “2” for communication path 1, “1” for communication path 2, and “1” for communication path 4500, the time T3 accumulated values are updated such that communication path 1 is 1+2=3, communication path 2 is 0+1=2, . . . , communication path 4500 is 2+1=3. The statistical information accumulated values in the statistical information accumulated value table 30e are similarly updated in times T4 and T5 such that, at the time T5, the communication path 1 is “4”, the communication path 2 is “2”, . . . , the communication path 4500 is “4”.

For example, Japanese Laid-open Patent Publication No. 6-132967 is disclosed as related art.

### SUMMARY

According to an aspect of the invention, an apparatus includes a counter circuit that counts a value of statistical information of a communication path for certain time periods; a memory; and a control circuit that acquires the value of the statistical information from the counter circuit and causes the memory to store the value of the statistical information when the value of the statistical information acquired by the counter circuit reaches a threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an example of an optical transmitting device configuration.

FIG. 2 is an example of a configuration of a statistical information processing circuit according to first and second embodiments.

FIG. 3 illustrates an example of statistical information collected and managed in an optical transmitting device.

FIG. 4 describes operations of the statistical information processing circuit according to the first embodiment.

FIG. 5 describes operations of the statistical information processing circuit according to the second embodiment.

FIG. 6 is an example of a configuration of a statistical information processing circuit according to a third embodiment.

FIG. 7 describes operations of the statistical information processing circuit according to the third embodiment.

FIG. 8 is an example of a configuration of a statistical information processing circuit according to a fourth embodiment.

FIG. 9 describes operations of the statistical information processing circuit according to the fourth embodiment.

FIG. 10 illustrates conventional polling processing by a CPU.

### DESCRIPTION OF EMBODIMENTS

The following is an explanation of embodiments of a transmitting device and an information acquisition control method (polling control method) disclosed in the present application with reference to the accompanying drawings. In the present embodiment, polling is not limited to the description herein and refers to processing in which a CPU acquires information from an HW counter and causes the information to be stored in a RAM. The transmitting device and information acquisition control method disclosed herein are not limited to the following embodiments.

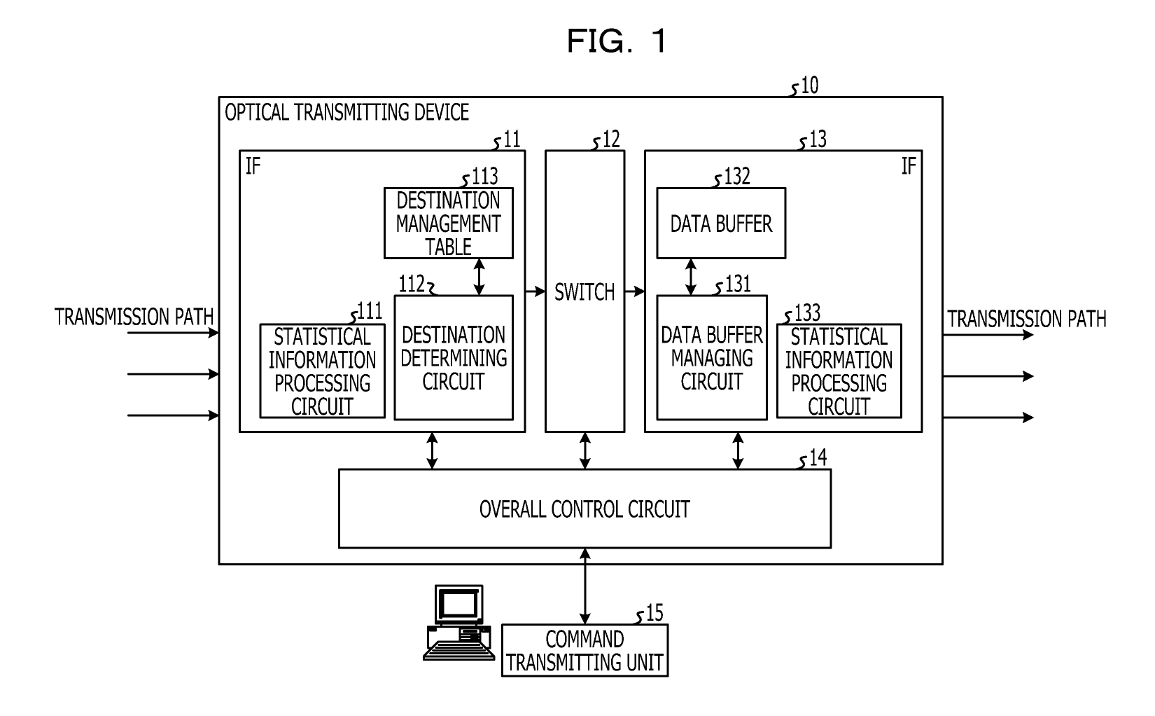

A configuration of an optical transmitting device according to a first embodiment disclosed herein will be described first. FIG. 1 is an example of an optical transmitting device configuration. As illustrated in FIG. 1, an optical transmitting device 10 includes an interface (IF) 11, a switch 12, an IF 13, and an overall control circuit 14. The components are coupled to allow for one-way or two-way inputting and outputting of signals and data. The IF 11, the switch 12, the IF 13, and the overall control circuit (processor) 14 may be physically implemented, for example, by a network (NW) card, a switch card, a NW card, and a CPU respectively.

The IF 11 analyzes received data inputted from a transmission path to collect and tally statistical information related to the amount and size of the data. The IF 11 includes a statistical information processing circuit 111, a destination determining circuit 112, and a destination management table 113. The components are coupled to allow for one-way or two-way inputting and outputting of signals and data. The statistical information processing circuit 111 is physically implemented by a CPU, for example, and manages the abovementioned statistical information. Details of the statistical information processing circuit 111 will be explained below. The destination determining circuit 112 is desirably physically implemented by a field-programmable gate array (FPGA), and determines a destination of the received data based on identification information attached to the received data and data in the destination management table 113. The identification information may be, for example, destination information or service type information. The destination management table 113 is physically implemented by a memory such as, for example, a RAM and the like, and is a table that manages a destination address, a transmission source address, a virtual local area network (VLAN) ID and the like.

The switch 12 switches output targets of the received data according to a determination result made by the destination determining circuit 112. Specifically, the switch 12 adds destination information to the received data to generate transmitting data which is outputted to a data buffer managing circuit 131.

The IF 13 transmits the transmitting data to a destination target according to the attached destination information. The IF 13 includes the data buffer managing circuit 131, a data buffer 132, and a statistical information processing circuit 133. The components are coupled to allow for one-way or two-way inputting and outputting of signals and data. The data buffer managing circuit 131 is physically implemented by a FPGA. The data buffer managing unit 131 stores transmitting data inputted from the switch 12 in the data buffer 132 and also reads out the transmission data stored in the data buffer 132 at a certain timing. The data buffer 132 is physically implemented by a memory such as, for example, a RAM, and temporarily stores the transmission data in conjunction with a timing to transmit the transmitting data. The statistical information processing circuit 133 is physically implemented by a processor such as, for example, a CPU and manages the abovementioned statistical information. Details of the statistical information processing circuit 133 will be explained below.

The overall control circuit 14 is physically implemented as a processor by, for example, the CPU, and monitors the IF 11, the switch 12, and the IF 13. A command transmitting unit 15 transmits a specific command to the overall control circuit 14 according to an instruction input by a user. For example, when the user inputs a threshold setting command concerning the communication paths, the command transmitting unit 15 loads the instructed threshold in the overall control circuit 14.

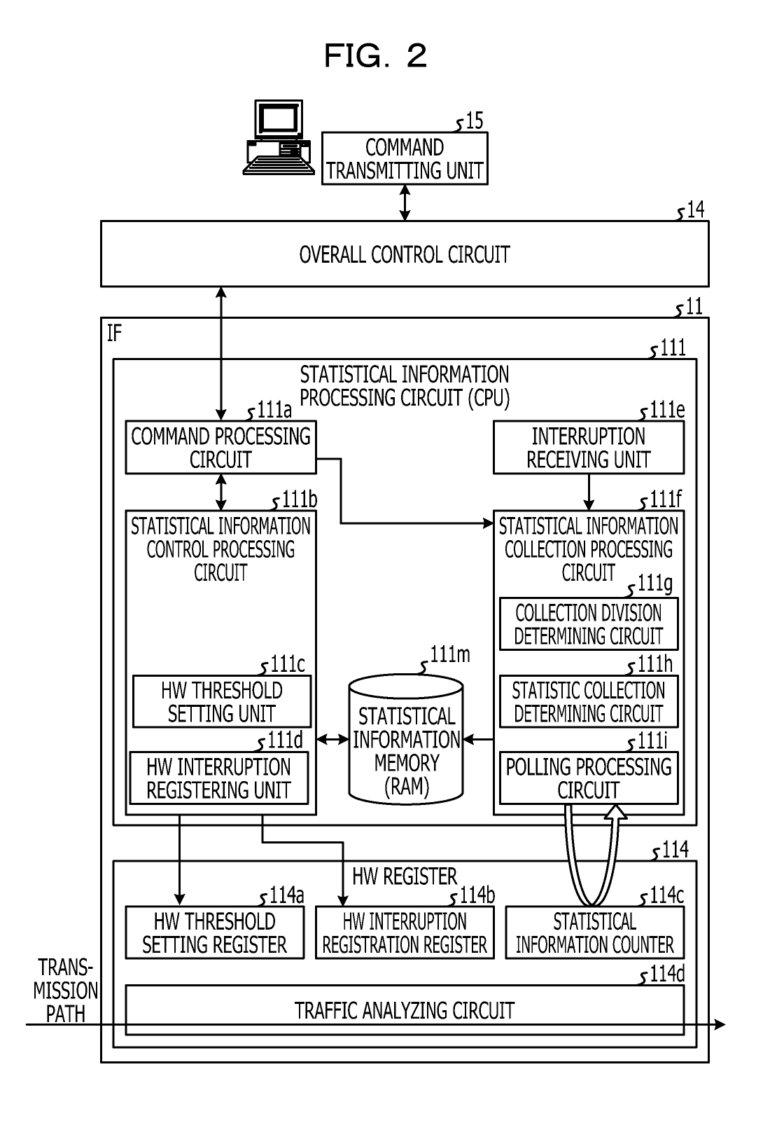

The following is a description of the abovementioned statistical information processing circuits 111 and 133. The explanation below describes a configuration of the statistical information processing circuit 111 as a representative example. The statistical information processing circuit 133 has a similar configuration. FIG. 2 is an example of a configuration of the statistical information processing circuit 111. As illustrated in FIG. 2, the statistical information processing circuit 111 includes a command processing circuit 111a, a statistical information control processing circuit 111b, an interruption receiving unit 111e, a statistical information collection processing circuit 111f, and a statistical information memory 111m. The components are coupled to allow for one-way or two-way inputting and outputting of signals and data.

The command processing circuit 111a sets a threshold for the communication paths 1 to 4500 according to a command transmitted from the command transmitting unit 15. A shared threshold of “4” is set for all the communication paths in the present embodiment. However, the threshold may be set individually by the user with different values for the communication paths. The command processing circuit 111a receives the above command via the overall control circuit 14 and outputs the command to the statistical information control processing circuit 111b.

The statistical information control processing circuit 111b includes a HW threshold setting unit 111c and a HW interruption registering unit 111d. The HW threshold setting unit 111c sets, as a HW threshold in a HW threshold setting register 114a, a threshold to cause the statistical information memory 111m to store the value of the statistical information acquired by a statistical information counter 114c. The statistical information counter 114c may be, for example, a logic circuit that conducts counting. The HW interruption registering unit 111d registers the generation of an interruption of the CPU in a HW interruption registration register 114b when a statistical information counter value reaches the threshold set by the HW threshold setting unit 111c. Preliminary setting in the polling processing is completed by the setting processing conducted by the HW threshold setting unit 111c and the registration processing conducted by the HW interruption registering unit 111d.

The interruption receiving unit 111e receives an interruption notification from the hardware and outputs the interruption notification to the statistical information collection processing circuit 111f.

The statistical information collection processing circuit 111f includes a collection division determining circuit 111g, a statistic collection determining unit 111h, and a polling processing circuit 111i. The collection division determining circuit 111g determines whether or not the statistical information is divided and collected during the statistical information polling. The statistic collection determining unit 111h determines whether or not statistical information polling is conducted according to whether or not the statistical information reaches the HW threshold. The polling processing circuit 111i conducts polling on communication paths in which an interruption was generated according to the determination result by the statistic collection determining unit 111h. Specifically, the polling processing circuit 111i collects the value of the statistical information stored in the statistical information counter 114c of a HW register 114 and updates the value of the statistical information in the statistical information memory 111m by causing the statistical information memory 111m to store the collected value of the statistical information.

The statistical information memory 111m stores the value of the statistical information acquired by the polling processing circuit 111i from the HW register 114 to allow for updating. The stored value of the statistical information is referred to by the statistical information control processing circuit 111b upon the setting of the HW threshold and the registration of the HW interruption.

The HW register 114 includes the HW threshold setting register 114a, the HW interruption registration register 114b, the statistical information counter 114c, and a traffic analyzing circuit 114d. The HW threshold setting register 114a stores a statistical information collection threshold set by the HW threshold setting unit 111c as the HW threshold. The HW interruption registration register 114b stores the generation of an interruption on a CPU registered by the HW interruption registering unit 111d. The statistical information counter 114c counts errors and the like generated in the communication paths of the optical transmission device 10, and stores the count value as statistical information. The statistical information counter 114c also outputs the statistical information stored at the polling time to the statistical information processing circuit 111 in response to a request from the polling processing circuit 111i. The statistical information counter 114c is a read-clear counter and thus clears the value of the statistical information to “0” accompanying the polling. The traffic analyzing circuit 114d analyzes a traffic state of transmission lines based on the value of the statistical information of the statistical information counter 114c. The traffic analyzing circuit 114d may be implemented, for example, by a network processing unit (NPU).

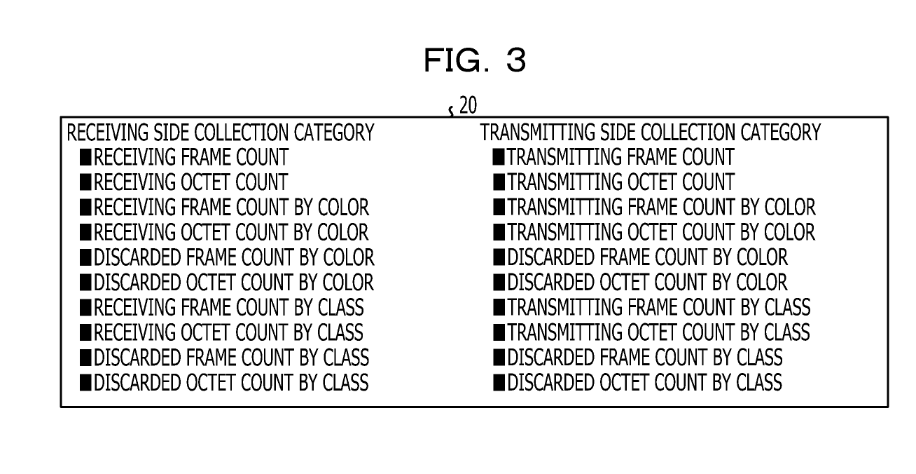

FIG. 3 illustrates an example of statistical information 20 collected and managed in an optical transmitting device 10. As illustrated in FIG. 3, the statistical information 20 is grouped into a receiving side collection category and a transmitting side collection category, and frame count and octet count are set according to the type in each of the collection categories. The frame count is grouped and managed as a receiving frame count, a receiving frame count by color, a discarded frame count by color, a receiving frame count by class, and a discarded frame count by class in the receiving side collection category. The transmission frame count is managed in a similar way in the transmitting side collection category. The octet count is grouped and managed as a receiving octet count, a receiving octet count by color, a discarded octet count by color, a receiving octet count by class, and a discarded octet count by class in the receiving side collection category. The transmission octet count is managed in a similar way in the transmitting side collection category. The color types may be, for example, three types such as green, yellow, and red. The class types may be, for example, eight types such as A, B, C, D, E, F, G, and H.

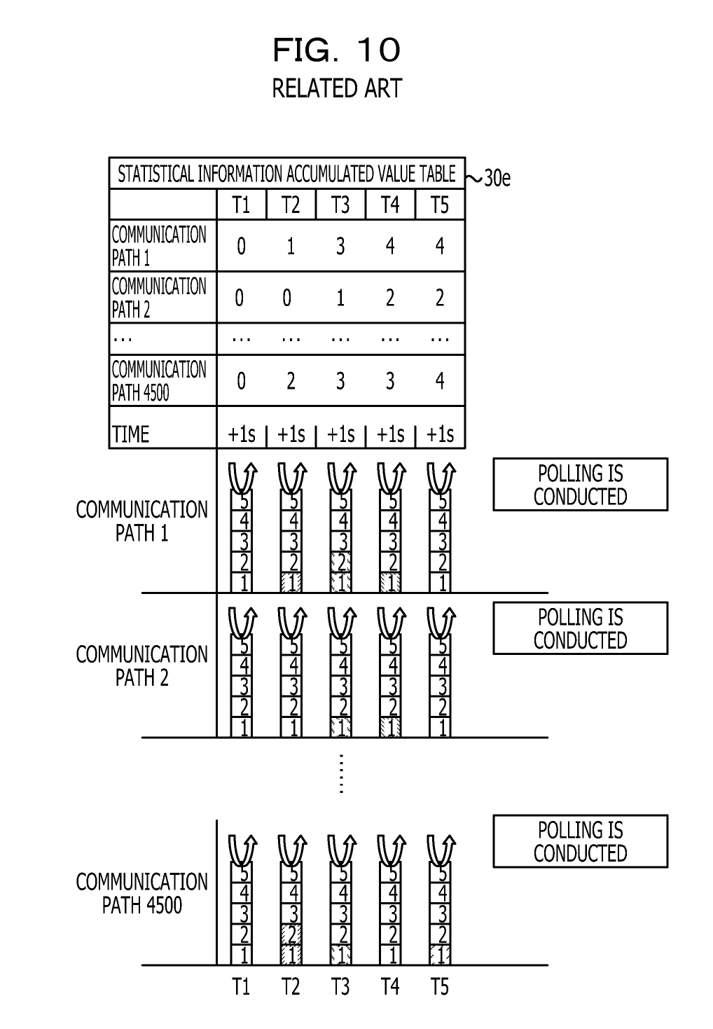

An explanation of conventional polling processing will be provided again with reference to FIG. 10 to make a comparison with the optical transmission device 10 according to the present embodiment. FIG. 10 illustrates conventional polling processing by a CPU. In FIG. 10, the time axis is defined by the horizontal axis and the counter value of the statistical information for each communication path is defined by the vertical axis. Polling is conducted on all the communication paths 1 to 4500 every second. The value of the statistical information accumulated in the HW register 114 is read out every second by the CPU and stored in the statistical information memory 111m. The statistical information accumulated value table 30e indicates accumulated values of statistical information counter values in the times T1 to T5 for each communication path 1 to 4500.

For example, in the time T1, all the communication paths are polled together. However, the accumulated value of the statistical information read out as a result of the polling is “0” since no statistical information has been accumulated in any of the communication path HW registers. Therefore, a region corresponding to the time T1 in the statistical information accumulated value table 30e indicates the settings communication path 1 is “0”, communication path 2 is “0”, . . . , communication path 4500 is “0”. Similarly, all the communication paths are polled together in the time T2. One count of statistical information is accumulated in the HW register of the communication path 1 at time T2, and two counts of statistical information are accumulated in the HW register of the communication path 4500. Therefore, the accumulated value of the statistical information read out as a result of the polling is updated in the statistical information accumulated value table 30e as communication path 1 is “1”, communication path 1 is “0”, . . . , communication path 4500 is “2”.

All the communication paths are also polled together in the time T3. Two counts of statistical information are accumulated in the HW register of the communication path 1 at the time T3, and one count of statistical information is accumulated in the HW register of the communication path 4500. Further, the statistical information accumulated value table 30e indicates the settings communication path 1 is “1”, communication path 2 is “0”, . . . , communication path 4500 is “2”. Therefore, as a result of the polling at the time T3, the statistical information accumulated values are respectively updated to communication path 1=“3” (=1+2), communication path 2=“1” (=0+1), . . . , communication path 4500=“3” (=2+1). Similarly, the statistical information of the HW registers of the communication path 1 and communication path 2 are each polled at the time T4. As a result, the statistical information accumulated values are respectively updated to communication path 1=“4” (=3+1), communication path 2=“2” (=1+1), . . . , communication path 4500=“3” (=3+0). One polling is conducted on the HW register statistical information of the communication path 3 at the time T5. As a result, the statistical information accumulated values are respectively updated to communication path 1=“4” (=4+0), communication path 2=“2” (=2+0), . . . , communication path 4500=“3” (=3+1).

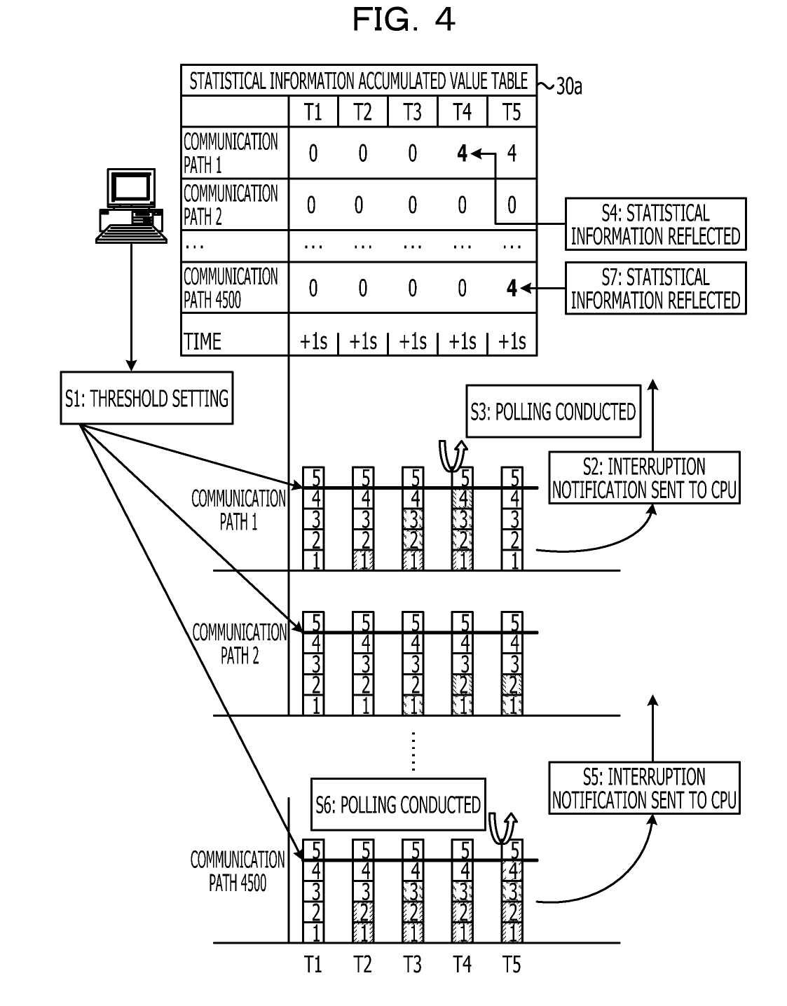

FIG. 4 describes operations of the statistical information processing circuit according to the first embodiment. At S1, a threshold of the HW register 114 counter value is set according to a command (CLI, SNMP, TL1, and the like) from a user. An interruption notification is sent to the statistical information processing circuit 111 (CPU) from the HW register 114 at the time T4 since the counter value reaches “4” which is the threshold at T4 (S2). The statistical information processing circuit 111 that receives the interruption notification conducts polling on the communication path 1 (S3). The statistical information processing circuit 111 causes the value of the statistical information read out from the HW register 114 due to the polling to be reflected in a statistical information accumulated value table 30a (S4).

The processing from S2 to S4 is similarly conducted at the time T5 for the communication path 4500. Specifically, the counter value of the statistical information of the communication path 4500 reaching the threshold that is “4” at the time T5 causes an interruption notification to be sent to the statistical information processing circuit 111 (CPU) from the HW register 114 (S5). The statistical information processing circuit 111 that receives the notification conducts polling on the communication path 4500 (S6). The statistical information processing circuit 111 causes the value of the statistical information read out from the HW register 114 due to the polling to be reflected in the statistical information accumulated value table 30a (S7). Since the statistical information counter value of the communication path 2 at this time is “2” which is less than the threshold, polling of the communication path 2 is not conducted and the statistical information accumulated value remains at the initial value of “0”. As a result, the statistical information accumulated value at the time T5 becomes “4” for the communication path 1, “0” for the communication path 2, . . . , and “4” for the communication path 4500 as indicated in the statistical information accumulated value table 30a in FIG. 4.

As described above, the optical transmission device 10 according to the first embodiment includes the statistical information counter 114c, the statistical information 111m, the HW threshold setting unit 111c, and the polling processing circuit 111i. The statistical information counter 114c counts the value of the statistical information of each communication path at a specific time period (1 second). The statistical information memory 111m stores the value of the statistical information. The HW threshold setting unit 111c sets a threshold to cause the value of the statistical information memory 111m to store the value of the statistical information acquired by a statistical information counter 114c. The polling processing circuit 111i acquires the value of the statistical information from the statistical information counter 114c when the value of the statistical information acquired by the statistical information counter 114c reaches the above threshold, and causes the statistical information memory 111m to store the value of the statistical information. The value of the statistical information includes a count value of errors that occur in the communication paths of the optical transmitting device 10.

Specifically, instead of dividing and then polling the statistical information, a threshold is previously set in the HW register 114 of the optical transmission device 10 according to the first embodiment such that count values are accumulated in the HW register 114 until the threshold is reached. As a result, the optical transmission device 10 does not have to conduct polling on all the communication paths every second. In other words, since polling is only conducted on communication paths about to reach a state of being filled by the HW registers of each communication path, the frequency of polling is reduced and the load on the CPU conducting the polling is reduced.

Furthermore, the following effects may be expected due to the optical transmission device 10 according to the first embodiment. Firstly, since statistical information of the HW register 114 is read out without omission when the preset threshold is reached, no delay may be caused in the polling even if the number of communication paths increases later on. Secondly, since statistical information of the HW register 114 is read out without omission when the preset threshold is reached, omissions in the collection of the statistical information may be avoided in the optical transmission device 10. Thirdly, since the polling time is shortened due to the reduced frequency of the polling, adverse effects of the polling time on switching times to other machines may be reduced in the optical transmission device 10. Fourthly, since the polling time is shortened due to the reduced frequency of the polling, temporary stoppages of low priority functions may be avoided in the optical transmission device 10. As a result, for example, functions such as downloading and the like may be operated in normal time. Fifthly, power consumption of the optical transmission device 10 may be reduced due to the reduced CPU loads.

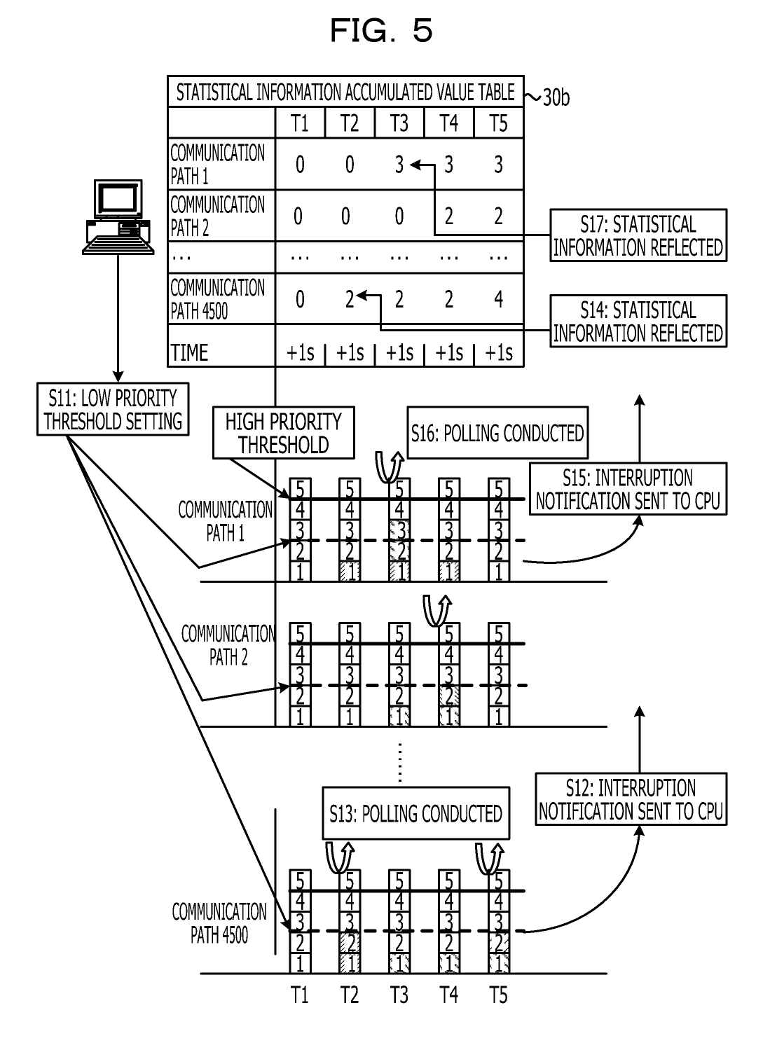

Next, a second embodiment will be explained. A configuration of an optical transmission device according to the second embodiment is substantially similar to that of the optical transmission device 10 according to the first embodiment illustrated in FIG. 1. A configuration of a statistical information processing circuit according to the second embodiment is substantially similar to that of the statistical information processing circuit 111 according to the first embodiment illustrated in FIG. 2. Therefore, detailed explanations will be omitted. The difference between the first and second embodiments is that multiple thresholds are provided for the statistical information counter value. Specifically, whereas one threshold is provided per communication path to determine a timing for conducting polling in the first embodiment, two stages of thresholds are established for each communication path to conduct polling in the second embodiment. The following explanation will focus on the operations of the statistical information processing circuit according to the second embodiment that are different from the first embodiment with reference to FIG. 5.

FIG. 5 describes operations of the statistical information processing circuit according to the second embodiment. In the present embodiment, the communication path counter values in the HW register 114 are assumed for the ease of explanation to be set with 5 stages 0 to 5. As illustrated in FIG. 5, the user loads the threshold “4”, which is the same as the first embodiment, as a high priority threshold in relation to the communication paths 1 to 4500 through the command transmitting unit 15. Similarly, the user also loads a new threshold “2” as a low priority threshold through the command transmitting unit 15 according to a command (e.g., CLI, SNMP, TL1, and the like) (S11). The processing from S12 to S17 is similar to the respective processing from S2 to S7 in the first embodiment. Therefore, a detailed explanation will be omitted. Specifically, the processing for steps S12, S13, and S14 in FIG. 5 correspond respectively to the processing in steps S5, S6, and S7 in FIG. 4, and processing in steps S15, S16, and S17 correspond respectively to the processing in steps S2, S3, and S4 in FIG. 4.

The above commands are received by the command processing circuit 111a through the overall control circuit 14. The command processing circuit 111a outputs the received commands to the statistical information control processing circuit 111b. The HW threshold setting unit 111e sets the abovementioned loaded high priority and the low priority thresholds in the HW threshold setting register 114a. As a result, both the low priority threshold and the high priority threshold are set in the HW register 114 for the communication paths. The HW interruption registering unit 111f registers interruptions from both the high and low priority thresholds in the HW interruption registration register 114b. As a result, the HW register 114 is able to notify the CPU about an interruption when an accumulated statistical information counter value reaches a threshold. The polling processing circuit 111i does not conduct polling so long as no interruption notifications are received from the HW registers.

At the time T1 in FIG. 5, none of the thresholds are reached in any of the communication paths 1 to 4500 since no statistical information for any of the communication paths is accumulated yet, and thus the CPU does not conduct polling. At the time T2, an interruption notification is sent to the CPU from the HW register 114 since the HW register statistical information counter value of the communication path 4500 reaches the low priority threshold. The CPU receives the interruption notification from the interruption receiving unit 111e and outputs the interruption notification to the statistical information collection processing circuit 111f. The polling processing circuit 111i conducts polling on the communication path 4500 in which the interruption was generated so long as there is no interruption notification that indicates that a threshold was reached in another communication path. The situation in which no interruption notification to indicate that a threshold has been reached in another communication path may arise because a maximum number other than the low priority threshold of communication paths to be polled by the CPU may be previously set, and that maximum number has not been reached yet.

The CPU collects the value of the statistical information from the statistical information counter 114c and updates the statistical information memory 111m. As a result, the value of the statistical information collected by the polling is reflected in a statistical information accumulated value table 30b. The statistical information accumulated value of the communication path 4500 at the time T2 is updated from “0” to “2”. The statistical information counter 114c is a read-clear counter and thus automatically clears the value of the statistical information of the HW register 114 to “0” accompanying the polling.

At the time T3, similar processing as conducted on the communication path 4500 as described above is conducted on the communication path 1 since the low priority threshold is reached in the communication path 1. At the time T4, similar processing as conducted on the communication path 4500 as described above is conducted on the communication path 2 since the low priority threshold is reached in the communication path 2. Furthermore, at time T5, the similar processing as described above is conducted on the communication path 4500 since the low priority threshold is reached again in the communication path 4500.

As described above, the HW threshold setting unit 111c in the optical transmission device 10 according to the second embodiment sets a first threshold and a second threshold that is lower than the first threshold. The polling processing circuit 111i acquires the value of the statistical information that has reached the second threshold from the statistical information counter 114c when the value of the statistical information reaches the second threshold and while the number of communication paths in which the value of the statistical information has reached the first threshold is not more than a certain value, and causes the statistical information memory 111m to store the value of the statistical information. Specifically, according to the optical transmission device 10 of the second embodiment, multiple statistical information thresholds are previously set in relation to all the communication paths 1 to 4500. When the statistical information of any of the communication paths reaches the low priority threshold, the number of communication paths that reach the high priority threshold is tallied. If the number of communication paths that have reached the high priority threshold is lower than a threshold (for example, 100 of the 4500 communication paths), the optical transmission device 10 conducts polling on the communication paths that have reached the low priority threshold. As a result, the timing of the polling of the communication paths is distributed and the occurrence of a large number of communication paths reaching the high priority threshold at one timing is avoided. Moreover, polling of other communication paths at the low priority threshold is not conducted at a timing in which the number of communication paths that have reached the high priority threshold has reached or exceeded the above threshold.

The following effects, for example, can be expected according to the optical transmission device 10 of the second embodiment. Firstly, the optical transmission device 10 may cause the polling to be completed within a desired time period thus allowing no polling delays even if the number of communication path increases dramatically later on. Secondly, the optical transmission device 10 may cause the polling to be completed within a desired time period and omissions in the collection of the statistical information may be avoided. Thirdly, the optical transmission device 10 may minimize effects on functions with an emphasis on performance, such as switching time and the like, since the time period for polling is dramatically reduced. Fourthly, the optical transmission device 10 may avoid a state in which low priority processing is not conducted thus allowing for the continuous operation of downloading and other functions since the time period for polling is dramatically reduced. Fifthly, the CPU load is reduced and power consumption of the entire device is also reduced in comparison to the state in which the polling on all the communication paths is conducted continuously (see FIG. 10).

When the number of communication paths that have not reached the high priority threshold is lower than the above threshold in the optical transmission device 10, polling is conducted on the communication paths that have reached the low priority threshold. However, the communication paths subject to polling at this time may not necessarily be all the communication paths (4500 communication paths) that have reached the low priority threshold. Specifically, an upper limit such as 100 to 1000 of the 4500 communication paths may be determined ahead of time such that the optical transmission device 10 may not conduct polling on the communication paths that exceed that value even if those communication paths have reached the low priority threshold. As a result, a large CPU load caused by concentrated polling at the low priority threshold may be reduced.

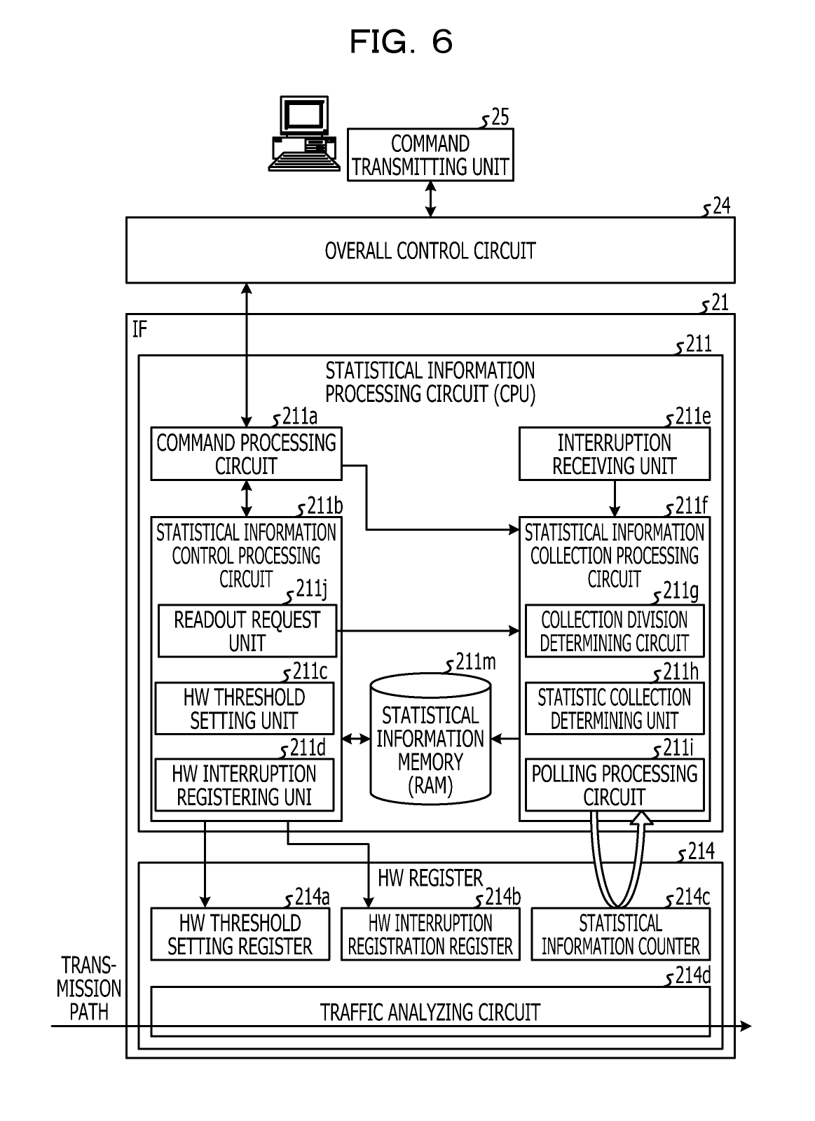

Next, a third embodiment will be explained. A configuration of an optical transmission device according to the third embodiment is substantially similar to that of the optical transmission device 10 according to the first embodiment illustrated in FIG. 1. FIG. 6 is an example of a configuration of a statistical information processing circuit 211 according to the third embodiment. As illustrated in FIG. 6, the configuration of the statistical information processing circuit 211 according to the third embodiment is substantially similar to that of the statistical information processing circuit 111 according to the first embodiment illustrated in FIG. 2, except that the statistical information processing circuit 211 further includes a readout request unit 211j. Therefore, similar constituent elements are indicated with reference numerals with the same ending and detailed explanations thereof will be omitted.

An IF 21, an overall control circuit 24, and a command transmitting unit 25 correspond respectively to the IF 11, the overall control circuit 14, and the command transmitting unit 15 according to the first embodiment. A statistical information processing circuit 211 and a HW register 214 correspond respectively to the statistical information processing circuit 111 and the HW register 114. A command processing circuit 211a, a statistical information control processing circuit 211b, an interruption receiving unit 211e, and a statistical information collection processing circuit 211f correspond respectively to the command processing circuit 111a, the statistical information control processing circuit 111b, the interruption receiving unit 111e, and the statistical information collection processing circuit 111f. A statistical information memory 211m corresponds to the statistical information memory 111m. A statistical information control processing circuit 211b, a HW threshold setting unit 211c, and a HW interruption registering unit 211d correspond respectively to the statistical information control processing circuit 111b, the HW threshold setting unit 111c, and the HW interruption registering unit 111d. A collection division determining circuit 211g, a statistic collection determining unit 211h, and a polling processing circuit 211i of the statistical information collection processing circuit 211f correspond respectively to the collection division determining circuit 111g, the statistic collection determining unit 111h, and the polling processing circuit 211i of the statistical information collection processing circuit 111f. A HW threshold setting register 214a, a HW interruption registration register 214b, and a statistical information counter 214c of the HW register 214 correspond respectively to the HW threshold setting register 114a, the HW interruption registration register 114b, and the statistical information counter 114c of the HW register 114. A traffic analyzing circuit 214d is a constituent element that corresponds to the traffic analyzing circuit 114d.

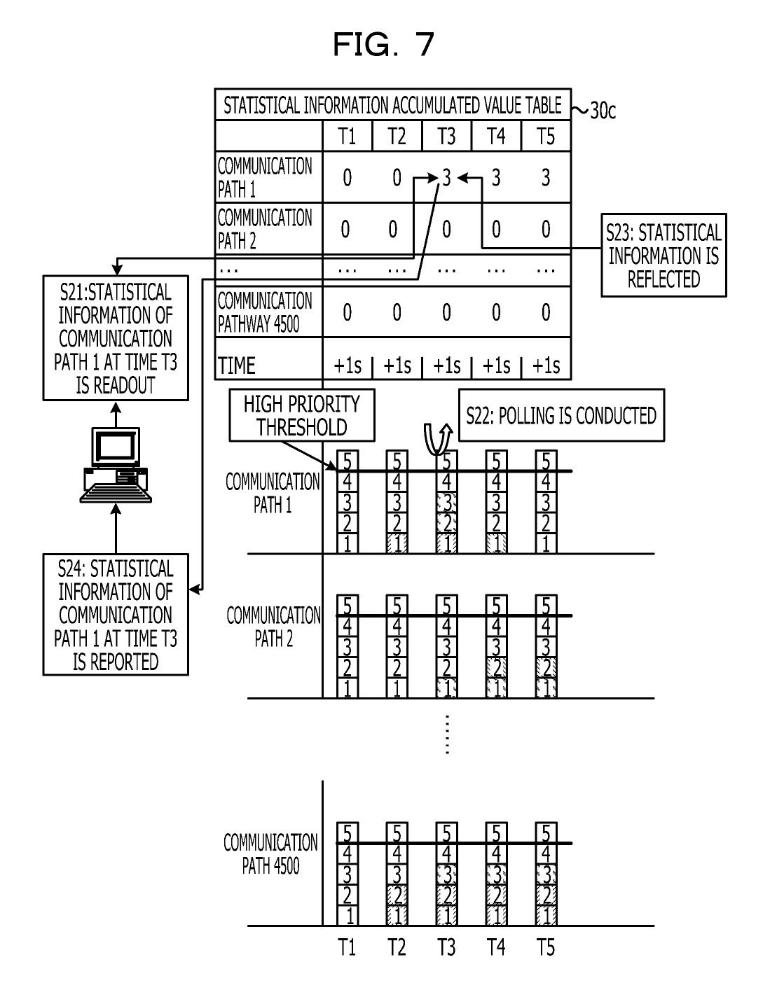

A difference between the first embodiment and the third embodiment is that the statistical information processing circuit 211 requests a statistical information readout of an arbitrary communication path at an arbitrary timing. Specifically, while polling is conducted when a threshold is reached in the first embodiment, polling is conducted when a statistical information readout is requested in the third embodiment. The following explanation will focus on the operations of the statistical information processing circuit according to the third embodiment that are different from the first embodiment with reference to FIG. 7.

The following is an explanation of the readout request unit 211j that represents a main difference from the first and second embodiments. The readout request unit 211j instructs the statistical information collection processing circuit 211f to conduct polling of the HW register 214 at a timing specified by a user or at a timing previously set in the optical transmission device 10. As a result, the readout request unit 211j collects value of the statistical information tallied in the statistical information counter 214c when a readout is requested regardless of whether or not the value of the statistical information reaches a threshold, thus allowing the tallied statistical information to be reflected in the statistical information memory 211m.

FIG. 7 describes operations of the statistical information processing circuit according to the third embodiment. At S21 in FIG. 7, a readout of the statistical information of the communication path 1 is requested at the time T3 according to a command (for example, CLI, SNMP, TL1, and the like) from the user. When the statistical information processing circuit 211 receives the readout request, the statistical information processing circuit 211 conducts polling on the communication path 1 at the time T3 (S22). The statistical information processing circuit 211 causes the statistical information collected from the HW register 214 in the polling to be reflected in a statistical information accumulated value table 30c (S23). As a result, the accumulated value of the statistical information of the communication path 1 at the time T3 in the statistical information accumulated value table 30c is updated from “0” to the counter value “3” of the statistical information accumulated in the HW register 214 up to the readout request time (T3). The result of the updating is reported to the user as a response value of the statistical information at the time T3 of the communication path 1 (S24).

As illustrated in FIG. 7, it is assumed at the time T3 that no communication path subject to polling in the times T1 to T5 is present. In this case, although the value of the statistical information is accumulated in the HW registers, the value of the statistical information managed by the CPU is “0”, that is, in a state in which nothing has been counted. When the user inputs a readout request command for the statistical information of the communication path 1 at the time T3, the command processing circuit 211a receives the command through the overall control circuit 24. Next, the readout request unit 211j instructs the polling processing circuit 211i to collect statistical information. The polling processing circuit 211i then collects the statistical information of the communication path 1 at the time T3. Specifically, the polling processing circuit 211i collects the current condition of the statistical information from the statistical information counter 214c and updates the counter value in the statistical information memory 211m from “0” to “3”. As a result, the statistical information counter 214 is read and cleared and the counter value is set to “0”. The command processing circuit 211a acquires, from the statistical information memory 211m, the statistical information accumulated value “3” of the communication path 1 for which the statistical information readout was requested, and generates response data to send to the user. The command processing circuit 211a then reports the statistical information readout result to the user.

As described above, the optical transmission device 10 according to the third embodiment includes the readout request unit 211j and the polling processing circuit 211i. The readout request unit 211j requests a readout for causing value of the statistical information to be stored in the statistical information memory 211m. The polling processing circuit 211i acquires the value of the statistical information from the statistical information counter 214c before the value of the statistical information acquired by the statistical information counter 214c reaches the above threshold and then causes the value of the statistical information to be stored in the statistical information memory 211m, in response to the request from the readout request unit 211j.

As a result, the optical transmission device 10 according to the third embodiment may avoid possible problems due to the provision of a statistical information threshold. Specifically, if the statistical information is not polled until a threshold has been reached, an interval between collections is increased so that a condition in which the value of the statistical information is accumulated only in the HW register 214 continues. As a result, an accurate measurement value may not be reflected in the CPU side for a long time. For example, if no communication path that has reached the threshold is present at any timing during the times T1 to T5 in FIG. 7, there is a concern that value of the statistical information of the hardware side is not stored in the RAM even at the time T5. The optical transmission device 10 according to the third embodiment however is able to solve the above problem since polling of the statistical information (actual count values) can be conducted at a desired timing due to the readout request unit 211j. Therefore, the optical transmission device 10 according to the third embodiment includes, in addition to the effects described in the first embodiment, an effect of quickly removing a shift in actual measurement values caused by the occurrence of a time lag in updating the statistical information. As a result, the optical transmission device 10 may realize a reduction in the CPU load without making the user aware of the divided collection of the statistical information.

Although the accumulated value is sent to the user at a timing caused by a request for a readout of the statistical information from a command in the third embodiment, the present embodiment is not limited to such an aspect. Specifically, the statistical information processing circuit 211 may send accumulated values of statistical information from a time other than the readout request time corresponding to the above request command, that is, accumulated values of past statistical information (e.g., the times T1 or T2). As a result, the optical transmission device 10 may acquire accumulated values per communication path going back in the past before the current accumulated values (the presence or number of errors within a certain time period). Therefore, the user may see at any timing historical information of count values at a desired time. Moreover, the user may refer to count values of each communication path at each time. Therefore, for example, temporal changes in the statistical information of the communication paths may be observed to allow for the comparison of statistical information between communication paths at the same time. As a result, the identification of breakdown timings and breakdown locations based on the statistical information is made simpler.

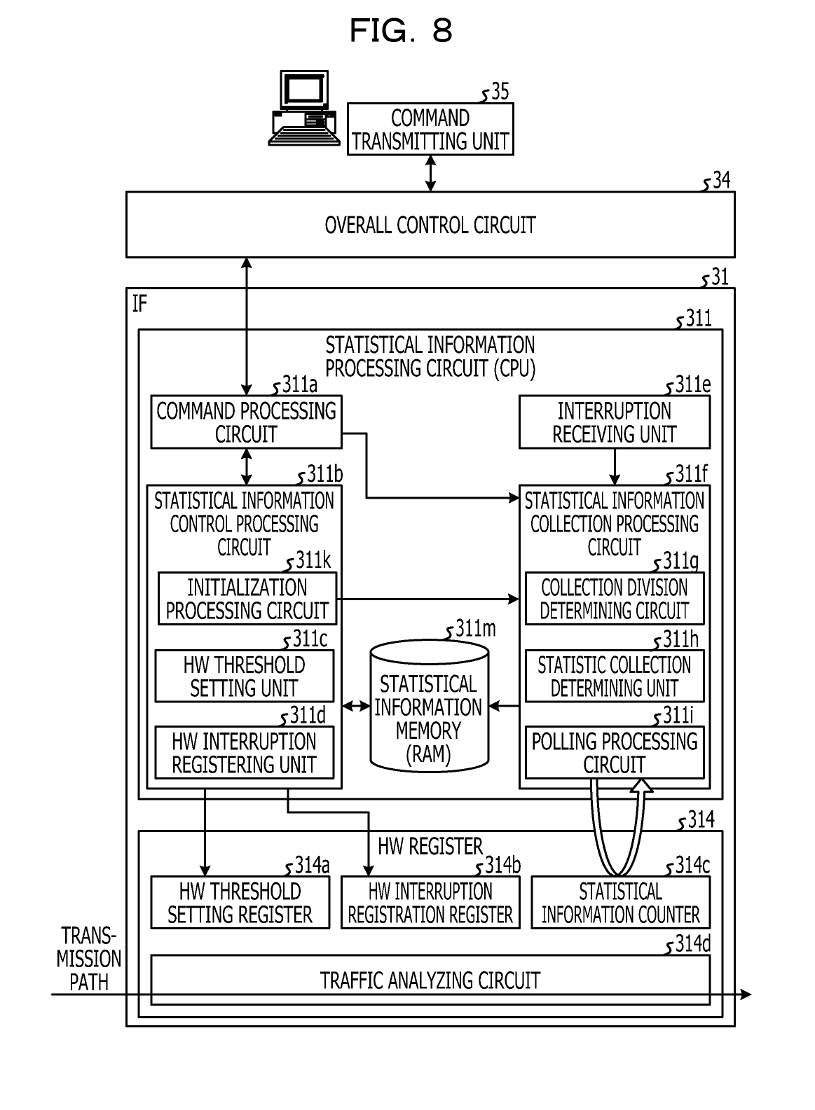

Next, a fourth embodiment will be explained. A configuration of an optical transmission device according to the fourth embodiment is substantially similar to that of the optical transmission device 10 according to the first embodiment illustrated in FIG. 1. FIG. 8 is an example of a configuration of a statistical information processing circuit 211 according to the fourth embodiment. As illustrated in FIG. 8, the configuration of the statistical information processing circuit 311 according to the fourth embodiment is substantially similar to that of the statistical information processing circuit 111 according to the first embodiment illustrated in FIG. 2, except that the statistical information processing circuit 211 further includes an initialization processing circuit 311k. Therefore, similar constituent elements are indicated with reference numerals with the same ending and detailed explanations thereof will be omitted.

Specifically, an IF 31, an overall control circuit 34, and a command transmitting unit 35 according to the fourth embodiment correspond respectively to the IF 11, the overall control circuit 14, and the command transmitting unit 15 according to the first embodiment. A statistical information processing circuit 311 and a HW register 314 correspond respectively to the statistical information processing circuit 111 and the HW register 114. A command processing circuit 311a, a statistical information control processing circuit 311b, an interruption receiving unit 311e, and a statistical information collection processing circuit 311f correspond respectively to the command processing circuit 111a, the statistical information control processing circuit 111b, the interruption receiving unit 111e, and the statistical information collection processing circuit 111f. A statistical information memory 311m corresponds to the statistical information memory 111m. A statistical information control processing circuit 311b, a HW threshold setting unit 311c, and a HW interruption registering unit 311d correspond respectively to the statistical information control processing circuit 111b, the HW threshold setting unit 111c, and the HW interruption registering unit 111d. A collection division determining circuit 311g, a statistic collection determining unit 311h, and a polling processing circuit 311i of the statistical information collection processing circuit 311f correspond respectively to the collection division determining circuit 111g, the statistic collection determining unit 111h, and the polling processing circuit 111i of the statistical information collection processing circuit 111f. A HW threshold setting register 314a, a HW interruption registration register 314b, and a statistical information counter 314c of the HW register 314 correspond respectively to the HW threshold setting register 114a, the HW interruption registration register 114b, and the statistical information counter 114c of the HW register 114. A traffic analyzing circuit 314d is a constituent element that corresponds to the traffic analyzing circuit 114d.

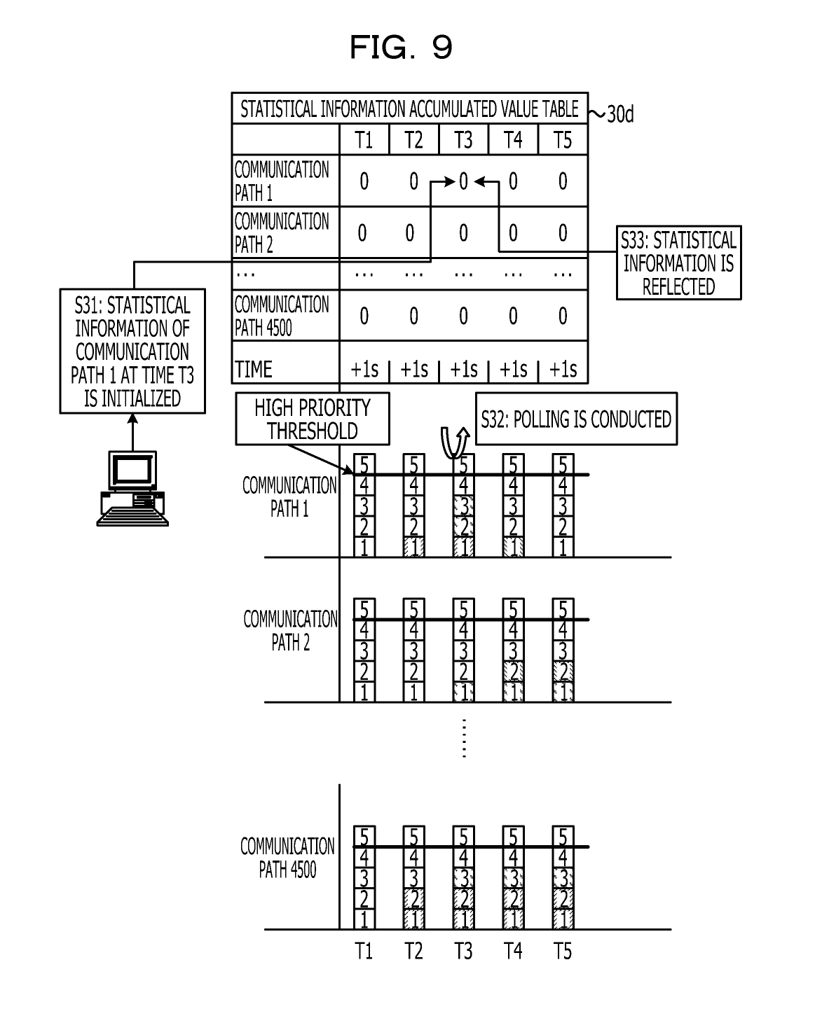

A difference between the first and the fourth embodiments is that initialization of statistical information and the accumulated value thereof is conducted by the statistical information processing circuit on an arbitrary communication path at an arbitrary timing. Specifically, while the polled statistical information is gradually accumulated in the first embodiment, the polled statistical information is initialized in the fourth embodiment. The following explanation will focus on the operations of the statistical information processing circuit according to the fourth embodiment that are different from the first embodiment with reference to FIG. 9.

The following is an explanation of the initialization processing circuit 311k that represents the main difference from the first and second embodiments. The initialization processing circuit 311k instructs the statistical information collection processing circuit 311f to conduct initialization of the HW register 314 at a timing specified by a user or at a timing previously set in the optical transmission device 10. As a result, the initialization processing circuit 311k clears the value of the statistical information tallied by the statistical information counter 314c when a request for initialization is received regardless of whether or not the value of the statistical information has reached a threshold, and the result of the initialization is reflected in the statistical information memory 311m.

FIG. 9 describes operations of the statistical information processing circuit according to the fourth embodiment. At S31 in FIG. 9, an initialization of the statistical information of the communication path 1 is requested at the time T3 according to a command (for example, CLI, SNMP, TL1, and the like) from the user. When the statistical information processing circuit 311 receives the initialization request, the statistical information processing circuit 311 conducts polling on the communication path 1 at the time T3 (S32). The statistical information processing circuit 311 causes the statistical information collected from the HW register 314 in the polling to be reflected in a statistical information accumulated value table 30d. As a result, the accumulated value of the statistical information of the communication path 1 at the time T3 in the statistical information accumulated value table 30d is updated from “0” to the counter value “3” of the statistical information accumulated in the HW register 314 at the initialization request time (T3). The once updated statistical information accumulated value “3” is further updated to “0” according to the initialization request command (S33). The statistical information of the communication path 1 and at the time T3 accumulated in the HW register 314 is also initialized along with the value in the statistical information accumulated value table 30d at this time. As a result, the statistical information from before the time the initialization was requested is reliably initialized. Therefore, the optical transmission device 10 allows for the initialization of not only the statistical information accumulated value, but also the HW register counter value at a desired timing for a desired communication path.

As illustrated in FIG. 9, it is assumed at the time T4 that no communication path subject to polling in the times T1 to T5 is present. In this case, although the statistical information is accumulated in the HW registers, the statistical information managed by the CPU is “0”, that is, in a state in which nothing has been counted. When the user inputs an initialization request command concerning the statistical information of the communication path 1 at the time T3, the command processing circuit 311a receives the command via the overall control circuit 34. The initialization processing circuit 311k then instructs the polling processing circuit 311i to collect statistical information. The polling processing circuit 311i then collects the statistical information of the communication path 1 at the time T3. Specifically, the polling processing circuit 311i collects the current condition of the statistical information from the statistical information counter 314c and updates the counter value in the statistical information memory 311m from “0” to “3”. As a result, the statistical information counter 314 is read and cleared and the counter value is set to “0”. The initialization processing circuit 311k initializes the accumulated value “3” to “0” of the statistical information of the communication path 1 stored in the statistical information memory 311m and for which the statistical information initialization was requested.

As described above, the optical transmission device 10 according to the fourth embodiment includes the initialization processing circuit 311k and the polling processing circuit 311i. The initialization processing circuit 311k requests statistical information initialization. The polling processing circuit 311i acquires the value of the statistical information from the statistical information counter 314c before the value of the statistical information acquired by the statistical information counter 314c reaches the above threshold, and causes the statistical information memory 111m to store the value of the statistical information in response to the request from the initialization processing circuit 311k. The initialization processing circuit 311k initializes the value of the statistical information stored in the statistical information memory 311m.

As a result, the optical transmission device 10 according to the fourth embodiment may avoid possible problems due to the provision of a statistical information threshold. Specifically, if the statistical information is not polled until a threshold has been reached, an interval between collections is increased so that a condition in which the value of the statistical information is accumulated only in the HW register 314 continues. As a result, an accurate measurement value may not be reflected in the CPU side for a long time. In this case, there is a concern that, during pre-operation testing and the like, initialization expected by the user may not be conducted in the optical transmission device 10. The optical transmission device 10 according to the fourth embodiment however is able to solve the above concern since initialization after the polling of the statistical information (actual count values) may be conducted at a desired timing by the initialization processing circuit 311k. Therefore, the optical transmission device 10 according to the fourth embodiment exhibits, in addition to the effects described in the first embodiment, an effect of quickly removing an omission of statistical information initialization caused by the occurrence of a time lag in updating the value of the statistical information. As a result, the optical transmission device 10 may realize a reduction in the CPU load without making the user aware of the dividing and collecting of the statistical information.

The counter values and accumulated values of the statistical information at the time T3 of the communication path 1 are initialized due to a command in the fourth embodiment, however the present embodiment is not limited to such an aspect. Specifically, a configuration may be provided that allows for appropriate modification of the counter value and the accumulated value of the statistical information subject to the initialization through a setting in the optical transmission device 10 or through a user instruction. As a result, the user may initialize the value of the statistical information of a desired time per communication path at any timing. For example, when conducting a pre-operation test on a transmission line, or when an error in the accumulated value of the statistical information or the accumulated value of the statistical information occurs, or when accumulated value of the statistical information is not to be used, the optical transmission device 10 can initialize the value of the statistical information once and then restart tallying. As a result, the user is able to refer to accurate value of the statistical information when testing is being conducted or when collection is being redone.

Although initialization of both the HW register counter value and the statistical information accumulated value are initialized by the initialization command in the optical transmission device 10 of the fourth embodiment, either one or the other of the values may also be initialized.

According to the above embodiments, the maximum value of statistical information that can be accumulated in the HW registers of the communication paths is indicated as “5” for the ease of explanation. Similarly, although the statistical information counter value threshold is indicated as “4” and “2”, these values may be set as desired. Moreover, the setting method may be conducted according to an instruction from a user, or a systematic fixed value may be used. Although common thresholds were set for the communication path 1 to 4500 and the times T1 to T5 in the optical transmission device 10 according to the above embodiments, different thresholds may be set for each communication path or different values may be used for each time. For example, by setting thresholds for desired communication paths lower when establishing different settings for each communication path, the optical transmission device 10 may collect statistical information of the desired communication paths more quickly than the statistical information of other communication paths. For example, by setting thresholds for certain times lower when establishing different thresholds for each time, the optical transmission device 10 may collect the statistical information of more communication paths at the certain times. As a result, polling may be controlled according to communication path characteristics (allowable capacity of accumulation or concentration of statistical information) or temporal characteristics (concentration of statistical information and the like).

The above explanation describes individual configurations and operations for each embodiment. However, the optical transmission device according to each of the embodiments may also incorporate specific constituent elements from other embodiments. Combinations of the embodiment are not limited to two embodiments and various combinations may be employed. For example, an optical transmission device according to the second embodiment that allows for two threshold settings may also include the readout request unit 211j specific to the third embodiment, or the initialization processing circuit 311k according to the fourth embodiment. The optical transmission device according to the third embodiment may also include the initialization processing circuit 311k specific to the fourth embodiment. Moreover, one optical transmission device may combine all the constituent elements described in the first to fourth embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmitting device comprising:
a counter circuit that counts a value of statistical information of a communication path for certain time periods;
a memory; and
a control circuit that acquires the value of the statistical information from the counter circuit and causes the memory to store the value of the statistical information when the value of the statistical information acquired by the counter circuit reaches a threshold.

2. The transmitting device according to claim 1 further comprising:
a setting circuit that sets a first threshold and a second threshold lower than the first threshold, wherein
the control circuit acquires the value of the statistical information that has reached the second threshold from the counter circuit and causes the memory to store the value of the statistical information that has reached the second threshold when the value of the statistical information reaches the second threshold and when a number of communication paths in which the statistical information has reached the first threshold is not more than a certain value.

3. The transmitting device according to claim 1 further comprising:
a readout request unit that requests a readout for causing the memory to store the value of the statistical information, wherein
the control circuit acquires the value of the statistical information from the counter circuit and causes the memory to store the value of the statistical information before the value of the statistical information acquired by the counter circuit reaches the threshold when the request is received from the readout request unit.

4. The transmitting device according to claim 1 further comprising:
an initialization processing circuit that requests an initialization of the statistical information, wherein
the control circuit acquires the value of the statistical information from the counter circuit and causes the memory to store the value of the statistical information before the value of the statistical information acquired by the counter circuit reaches the threshold when the request is received from the initialization processing circuit, and
the initialization processing circuit initializes the value of the statistical information stored in the memory.

5. The transmitting device according to claim 1 wherein,
the value of the statistical information includes a count value of errors that occur in the communication paths of the transmitting device.

6. The transmitting device according to claim 1 wherein,
the control circuit acquires all the value of the statistical information from the counter circuit and causes the memory to store all the value of the statistical information.

7. An information acquisition control method comprising:
a transmitting device that
counts a value of statistical information of a communication path with a counter circuit for certain time periods;
sets a threshold to cause the a memory to store the counted value of the statistical information; and
acquires the value of the statistical information from the counter circuit and causes the memory to store the value of the statistical information when the counted value of the statistical information reaches the threshold.

8. The information acquisition control method according to claim 7 wherein,
the setting of the threshold includes
setting a first threshold and a second threshold lower than the first threshold; and
causing the storing by the memory includes
acquiring the value of the statistical information that has reached the second threshold from the counter circuit and causing the memory to store the value of the statistical information that has reached the second threshold when the acquired value of the statistical information reaches the second threshold and when a number of communication paths in which the value of the statistical information has reached the first threshold is not more than a certain value.

9. The information acquisition control method according to claim 7 wherein,
causing the storing by the memory includes
receiving a readout request for causing the memory to store the statistical information, and
acquiring the value of the statistical information from the counter circuit and causing the memory to store the statistical information before the acquired value of the statistical information reaches the threshold.

10. The information acquisition control method according to claim 7 wherein,
causing the storing by the memory includes
receiving a request for an initialization of the value of the statistical information,
acquiring the value of the statistical information from the counter circuit and causing the memory to store the value of the statistical information before the value of the statistical information acquired by the counter circuit reaches the threshold, and
initializing the value of the statistical information stored in the memory.

11. The information acquisition control method according to claim 7 wherein,
the value of the statistical information includes a count value of errors that occur in the communication paths of the transmitting device.

12. The information acquisition control method according to claim 7 wherein,
causing the storing by the memory includes acquiring all the value of the statistical information from the counter circuit.
